(19) United States
(12) Patent Application Publication
(10) Pub. No.: US 2024/0076933 A1
(43) Pub. Date: Mar. 7, 2024

(54) SHADE CONFIGURED TO BE CHANGED IN WIDTH AND HEIGHT AND CONFIGURED TO TRANSFORM BETWEEN DIFFERENT TYPES OF SHADES

(71) Applicant: Wondershades LLC, New York, NY (US)

(72) Inventor: Jason B. Teuscher, New York, NY (US)

(21) Appl. No.: 18/242,059

(22) Filed: Sep. 5, 2023

Related U.S. Application Data
(60) Provisional application No. 63/403,378, filed on Sep. 2, 2022.

(51) Int. Cl. E06B 9/262

(52) U.S. Cl. CPC E06B 9/262; E06B 2009/2622; E06B 2009/2625

(57) ABSTRACT

According to the one or more embodiments as described herein, a shade having at least a cloth can be transformed between different types of window shades with an adjustable length and width. For example, and according to the one or more embodiments described here, the window treatment may be transformed from a Flat Roman Shade to a Hobbled Roman Shade or a curtain. In addition to being utilized to cover a window, the window shade according to the one or more embodiments described herein may also be utilized as a shower curtain or a protective cover to, for example, cover furniture of different shapes and dimensions.

### CROSS-REFERENCE TO RELATED APPLICATIONS

The present application claims the benefit of U.S. Provisional Patent Application Ser. No. 63/403,378, which was filed on Sep. 2, 2022, by Jason B. Teuscher for SHADE CONFIGURED TO BE CHANGED IN WIDTH AND HEIGHT AND CONFIGURED TO TRANSFORM BETWEEN DIFFERENT TYPES OF SHADES, which is hereby incorporated by reference.

### BACKGROUND

### Field of the Invention

The present invention relates to a window shade configured to transform between types of window shades and can be adjusted in terms of width and height.

### Background Information

Window shades are mostly tailored in terms of size and shape for individual windows. Typically, manufacturers of window shades create shades, to be sold at retailers, for windows that are considered standard in terms of size and shape. Therefore, a consumer will have to have a window with the standard shape.

Furthermore, and importantly, once the fabric for the window shade is cut and sewn by, for example, a manufacturer, the window shade cannot typically be further modified. Moreover, exact measurements are required which can frustrate consumers since measuring windows is time consuming and precise measurements are required for fabric cutting and sewing, which adds additional costs and time. Using a single piece of fabric to transform a window treatment allows the consumer to not only create many tailored looks but also create an exact fit. This saves time and money and relieves the consumer of concerning measurements and frees the consumer to transform one traditional shade into another without the hassle of a new purchase. Manufacturing is simplified since the time and cost devoted to tailored processes are now able to manufacture in scale while still providing design and size flexibility. Additionally, classifications of window treatments have been hard wired into consumers since mix and matching designs are not available, by using a cloth with various attaching mechanisms new treatments can now be created.

### BRIEF DESCRIPTION OF THE DRAWINGS

The above and further advantages of the embodiments herein may be better understood by referring to the following description in conjunction with the accompanying drawings in which like reference numerals indicate identically or functionally similar elements, of which:

FIGS. 1A and 1B are respectively a front and a back view of a window shade with cloth according to the one or more embodiments described herein;

FIG. 2 is a profile view of front transforming members of a shade coupling to each other to modify a height of a shade according to the one or more embodiments as described herein;

FIG. 3 is a back side of a shade that includes ribbons that can be used to transform a shade form a first type to a second type according to the one or more embodiments as described herein;

FIGS. 4A and 4B are a front side and a back side, respectively, of the shade of FIG. 3 that is transformed to the second type according to the one or more embodiments as described herein;

FIG. 4C is a shade transformed to a second type utilizing clips that are coupled to each other according to the one or more embodiments as described herein;

FIG. 5 is a back side of a shade that includes a liner that is used to create a pleats/folds at a plurality of locations according to the one or more embodiments as described herein;

FIG. 6 is a front side of a shade that includes a liner that is used to create a pleats/folds at a plurality of locations according to the one or more embodiments as described herein; and

FIG. 7 is a shade that is used as an awning according to the one or more embodiments as described herein.

### DETAILED DESCRIPTION OF AN ILLUSTRATIVE EMBODIMENT

It is the primary objective of the present invention to provide a cloth for a window treatment, which can be transformed between different types of window shades with an adjustable length and width. For example, and according to the one or more embodiments described here, the window treatment may be transformed from a Flat Roman Shade to a Hobbled Roman Shade or a curtain. In addition to being utilized to cover a window, the window shade according to the one or more embodiments described herein may also be utilized as a shower curtain or a protective cover to, for example, cover furniture of different shapes and dimensions.

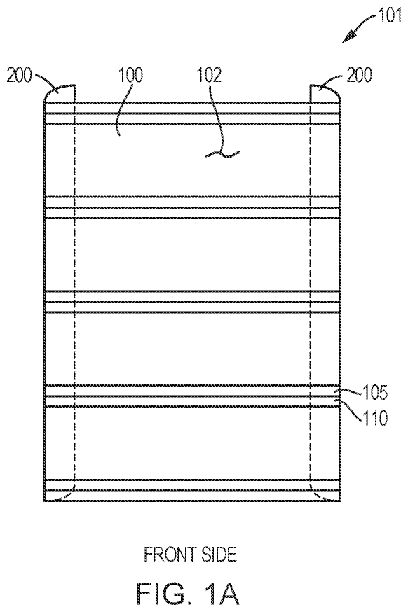

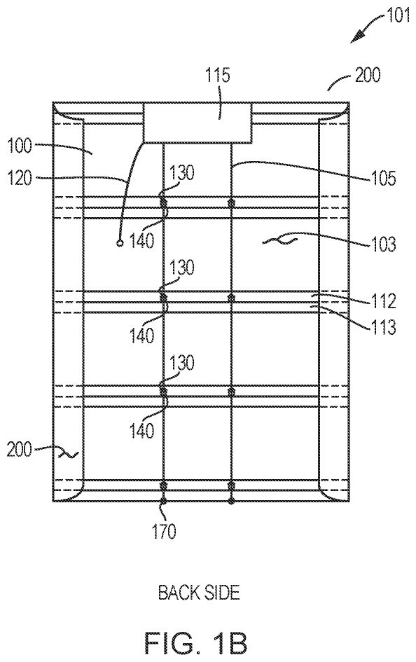

FIGS. 1A and 1B are respectively a front and a back view of a window shade 101 with cloth 100 according to the one or more embodiments described herein. The window shade 101 of FIGS. 1A and 1B is in a configuration of a flat front Roman shade. Specifically, cloth 100 of window shade 101 does not, for example, include one or more folds and instead is flat. In an embodiment, cloth 100 is a single piece of cloth. Cloth 100 may include a front side 102 and a back side 103. In an implementation, front side 102 may be the front side of the window shade 101 that is facing and visible to one or more individuals that may be on an interior side of the window of a window opening (not shown). In an implementation, back side 103 of window shade 101 may be the side of the window shade 101 that is facing the interior of the window that is not visible to the one or more individuals.

Window shade 101 may, in an embodiment, include a headrail 115 (visible in FIG. 1B but not visible in FIG. 1A) that is coupled to the cloth 100 such that a top of the cloth 100 may be secured to a top portion of a window opening by way of the headrail 115. In an embodiment, the window shade 101 may be secured to a window opening without the head rail 115 and instead utilizing any of a variety of different securing mechanisms that secure the cloth 100 directly to the frame of the window opening, for example.

As depicted in FIG. 1A, a plurality of front transforming members 105 and 110 may be coupled to cloth 100 at one or more different positions along the cloth 100. As depicted in FIG. 1A, each of the front transforming members 105 have a bottom surface that is in contact with the cloth 100 and a top surface that is not contact with the cloth 100.

As will be described in further detail below, the front transforming members 105 and 110 may transform/modify the height of the shade 101. In addition or alternatively, and as will be described in further detail below, the front transforming members 105 and 110 may transform shade 101 from a first type (e.g., flat front) of shade to a second type (e.g., pleated front with folds) of shade.

In an embodiment, and as described with reference to FIGS. 1A, the front transforming members 105 and 110 may be strips having a width that is less than, equal to, or greater than the width of the cloth 100 of window shade 101. Alternatively, and instead of being strips, the front transforming members 105 and 110 may be different units (not shown) that are positioned at one or more positions across or on cloth 100 of window shade 101.

Each of front transforming members 105 and 110 may have a bottom surface that is attached to the cloth 100 as depicted in FIG. 1A and includes a first portion of a securing mechanism. Front side 102 of cloth 100 may include one or more second portion of the securing mechanism that can mate with the first portions of the securing mechanism on the bottom surface of the front transforming members 105 and 110. As such, and when the bottom surfaces of the front transforming members 105 and 110 contact the front side 102 of cloth 100, the front transforming members 105 and 110 may attach to the cloth 100 of window shade 101 through the mating. In an implementation, the securing mechanism between the transforming members 105/110 and the front 102 of cloth 100 may be any of a variety of different types of securing mechanisms. Specifically, the type of securing mechanism may include, but is not limited to, hooks and loops, self-engaging hooks and loops, magnets, buttons, zippers, snaps, belt loops etc.

For example, the bottom surface of the front transforming members 105/110 may include a plurality of hooks and the front side 102 of cloth 100 may include a plurality of loops that mate to form a hook and loop type securing mechanism. As such, contact/engagement between plurality of hooks on the bottom surface of the front transforming members 105/110 and plurality of loops on the front side 102 of cloth 100 causes the front transforming members 105/110 to attach to the window shade 101.

Although reference is made to front side 102 of window shade 101 including both front transforming members 105 and 110 that are adjacent to each other at a particular location, it is expressly contemplated that only one of front transforming members 105 and 105 may be included with window shade 101 and at any of a variety of different locations and any of a variety of different sizes, which allows for different types of shades, e.g., transformation for a first type to a variety of different second types.

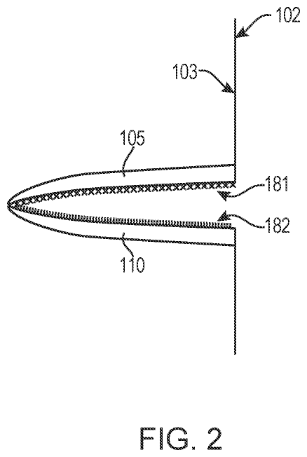

As will be described in further detail below and with reference to FIG. 2, the top surface of front transforming members 105 and 110 may respectively include different portions of a securing a mechanism (e.g., hooks and loops, self-engaging hooks and loops, magnets, button, zippers, snaps, belt loops etc.) such that the front transforming member 105 and 110 that are adjacent, for example, can be coupled to each other to modify/transform a height of the shade 101 and/or transform the shade from a first type to a second type.

FIG. 1B depicts back side 103 of cloth 100 of window shade 101 that is a flat front Roman shade. Back side 103 of window shade 101 may include back transforming members 112 and 113. As depicted in FIG. 1B, back transforming members 112 and 113 may include a bottom surface that is in contact with cloth 100 and a top surface that is not in contact with cloth 100. The back transforming members 112 and 113 may be located at one or more different positions on back side 103 of cloth 100. As will be described in detail below, the back transforming members 112 and 113 may be utilized to transform/modify a width and/or height of the window shade 101 according to the one or more embodiments described herein.

Although reference is made to back side 103 of window shade 101 including both back transforming members 112 and 113 that are adjacent to each other at a particular location, it is expressly contemplated that only one of back transforming members 112 and 113 may be included with window shade 101 and at any of a variety of different locations and any of a variety of different sizes. As such, any combination of front is transforming members 105/110 and back transforming members 112/113, that may be various sizes and at any locations on cloth 100, may be included with the shade 101 according to the one or more embodiments as described herein.

In a similar manner as described above with respect to front transforming members 105 and 110, the bottom surface of the back transforming members 112 and 113 may include a portion of a securing mechanism to couple/attach the back transforming members 112 and 113 to back side 103 of cloth 100. Additionally, and as described in further detail below, the top surface of back transforming members 112 and 113 may include different portions of a securing mechanism such that a width and/or height of shade 101 may be transformed/modified.

As depicted in FIG. 1B, the back side 103 of cloth 100 of window shade 101 may further include one or more raising clips 130. In an embodiment, a raising clip 130 may include an opening (e.g., hole) 140. In an embodiment, the raising clips 130 may be secured to the front of one or more back transforming members 112 and 113 as depicted in FIG. 1B utilizing any type of a different variety of securing mechanisms, as described above. In an implementation, one or more pull strings 125, of a raising mechanism (not shown) may travel from a location near the head rail 115 (which may be the raising mechanism itself or may house the raising mechanism) through each of the openings 140 of the one or more raising clips 130. For example, and as depicted in FIG. 1B, there are two pull strings 125, and each pull string 125 travels from a location near the head rail 115 through the openings 140 of a series of raising clips 130 that are at different vertical positions but at similar horizontal positions on the back side 103 of the cloth 100. In an implementation, the pull string 125 may have a bottom end that is furthest away from the raising mechanism that, for example, is within or adjacent the head rail 115. The bottom end of the pull string 125 may include a knot 170 or may simply be larger in size when compared to the opening 140 of a raising clip 130 that is a lowest positioned raising clip 130 on the cloth 100. Although reference is made to knot 170, it is expressly contemplated that any of a variety of different attachments may be secured to the bottom end of the pull string.

Although FIG. 1B illustrates the raising clips 130 being at particular locations on cloth 100, it is expressly contemplated that the raising clips may be at any locations on cloth 100 to, for example, accommodate different window shade configurations with differing locations of headrail 115 and pull strings 125, for example. In alternative embodiments a pull string 125 may not be required and the window shade 101, according to the one or more embodiments described herein, may operate as a roller shade (not shown) where the cloth 100 rolls onto a roller that is within the headrail 115.

Referring back to FIG. 1B, and when a pull cord 120 is pulled to raise the window shade 101, the pull strings 125 can retract/shorten and roll up on a rod or other component (not shown) of the raising system (not shown), and the bottom end of the pull strings 125, that is larger than the opening 140 of the lowest positioned raising clips 130, causes the cloth 100 of the shade 101 to be raised to different desired height, for example. Although the window shade 101 of FIGS. 1A and 1B include a pull cord 120 style raising mechanism, it is expressly contemplated that the window shade 101 according to the one or more embodiments described herein may be utilized with any of a variety of different types of raising mechanisms (e.g., motor, pull/push, roller etc.).

As previously mentioned, the window shade 101 according to the one or more embodiments described herein may be transformed/modified in terms of width such that the window shade 101 can fit different window openings having different widths. Specifically, and as depicted in FIG. 1B, the back transforming members 112 and 113 appear as horizontal strips with a front surface that is exposed and facing a window when the window shade 101 is within a window opening (the back surface of the back transforming members 112 and 113 are in contact and attached to the cloth 100). A left and right end portion of each of the back transforming members 112 and 113 may include a first portion of a securing mechanism while the other interior portions of the back transforming members 112 and 113 may include a second portion of the securing mechanism.

For example, let it be assumed that the back transforming members 112 and 113 are each 36 inches horizontally. In this example, 3 inches from the left and 3 inches from the right of the back transforming members may include a plurality of hooks. Additionally, the middle 30 inches may include a plurality of loops. As explained above, the back surface of the back transforming members 112 and 113 are attached to the cloth 100. Therefore, if a user were to fold/bend the cloth 100 6 inches on each side, the attached back transforming members 112 and 113 would also bend/fold such that the plurality of hooks on the two ends of the back transforming members 112 and 113 can mate with the plurality of loops in the interior portion of the back transforming members 112 and 113 such that the shade 101 is transformed to a 24 inch wide shade. The mating allows for the shade 101 to securely stay at this user desired width. As such, the user has the capability to modify the shade 101 to any width through the mating of the portions of is the securing mechanisms that are located at the ends and interior of the back transforming members 112 and 113.

Although reference is made to the back transforming members 112 and 113 including different portions of a securing mechanism, it is expressly contemplated that the entirety of the back transforming members may include a single type of securing mechanism that is self-engaging. For example, the top surface of the back transforming members 112 and 113 in their entirety may be mixed with a plurality of hooks and a plurality of loops such that any portion of the top surface can mate with a different portion of the top surface.

Additionally, the height of the shade 101 may be modified by way of mating of respective portions of securing mechanisms that are at different heights. For example, a user may fold/roll up a shade such that a back transforming member 112 and/or 113 at a lower position can mate with a back transforming member 112 and/or 113 at a higher position to reduce the height of the shade.

Therefore, the shade 101 according to the one or more embodiments described herein can be modified in terms of height and width utilizing the back transforming members 112 and 113, that may be at any locations on cloth 100, as described herein. FIGS. 1A and 1B show the flat front Roman shade with a modified width based on folded over portions 200 as described herein.

In an embodiment, the front transforming members 105 and 110 may be utilized to modify a height of the shade 101 and/or a style/type of the shade 101. As previously explained, each of the front transforming members 105 and 110 have a bottom surface that is in contact with the cloth 100 and a top surface that is not contact with the cloth 100. The top surface of adjacent front transforming members 105 and 110 may have respective portions of a securing mechanism. For example, a particular front transforming member 105 may have a plurality of loops while an adjacent transforming member 110 may have a plurality of hooks. As such, a user can “pinch” the cloth 100 from the back side such that the top surface of adjacent front transforming members 105 and 110 contact each other. FIG. 2 is a zoomed in version of shade 101 where two respective transforming members 105 and 110 that can mate together to modify a height of shade 101. Specifically, and as depicted in FIG. 2, transforming member 105 includes a first portion 181 of a securing mechanism that are indicated with diagonal lines. Further, transforming member 110 includes a second portion 182 of the securing mechanism as indicated with vertical lines. Therefore, a user can “pinch” the cloth 100 from the back side such that the top surface of adjacent front transforming members 105 and 110, which include the two portions of the securing mechanism, can couple and mate to modify the height of the shade.

For example, let it be assumed that each of two adjacent front transforming members 105 and 11 have a height of 4 inches. Therefore, and based on the pinching of the cloth on the back side such that the adjacent front transforming members contact and attach, the shade is reduced in height by 8 inches. Therefore, if the shade 101 includes 4 sets of adjacent front transforming members (e.g., a total of 8 front transforming members), the user can alter the shade to have a variety of different height and reduce the shade by a total 32 inches utilizing the front transforming members.

Additionally, and by pinching the cloth 100 as described above such that adjacent front transforming members contact and attach, the shade 101 transform from being a flat front to be a shade with one or more pleats/folds as depicted in FIG. 2. Specifically, a pleat is formed at each location where two adjacent front transforming members are attached based on the pinching of the cloth as described herein. Therefore, the shade 101 can be modified in terms of height and width as described herein with reference to FIGS. 1A, 1B, and 2.

Although reference is made to adjacent front transforming members 105 and 110 including different portions of a securing mechanism, it is expressly contemplated that the cloth 100 may include a single type of securing mechanism that is self-engaging. For example, the top surface of the a front transforming member 105 in its entirety may be mixed with a plurality of hooks and a plurality of loops such that the front transforming member 105 can be pinched in half (i.e., folded) as described above such that the top surface can mate with a different portion of the top surface. For example, if a front transforming member 105 is 8 inches in height, a user may pinch the cloth 100 from behind such that the front transforming member self-engages to reduce the height of the shade 101 by 8 inches and creates a pleat.

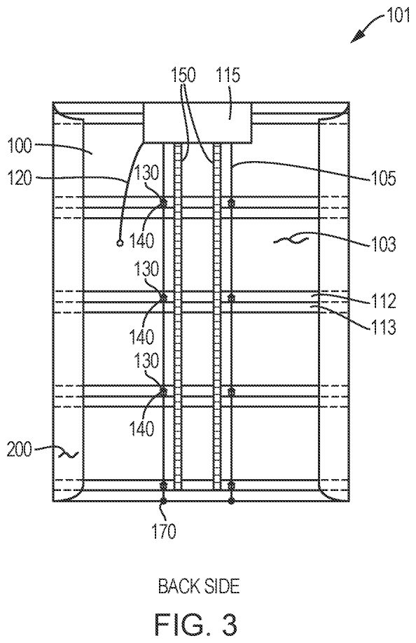

According to the one or more embodiments as described herein, the shade 101 may also be transformed to a hobbled or teardrop Roman shade. To transform the shade 101, shade 101 may include one or more ribbons 150 (e.g., two ribbons in FIG. 3) on the back of the shade 101. Although ribbons 150 in FIG. 3 has a particular configuration, it is expressly contemplated that ribbons 150 may be any material and configuration that traverses a particular length down a vertical distance of shade 101 such that different portions of the shade 101 can be attached to ribbons 150 to transform the shade 101 from a first type of shade (e.g., flat front Roman shade) to a second type of shade (e.g., is hobbled shade).

Specifically, and as depicted in FIG. 3, two ribbons 150 traverse a height of the shade 101 on the back of the shade 101. The raising clips 130, which are also depicted in FIG. 1B, are coupled to the back side of the cloth 100. The openings 140 of the raising clips 130 may engage with the ribbons 150 at different locations on the ribbons 150 to transform the shade 101 to a hobbled or teardrop Roman shade as depicted in the front view of FIG. 3. Thus, the shade 101 of FIG. 3 is transformed in (1) width utilizing the back transforming members 112 and 113, (2) in height utilizing the front transforming members 105 and 110, and (3) to a hobbled Roman shade utilizing the ribbons 150 and raising clips 130.

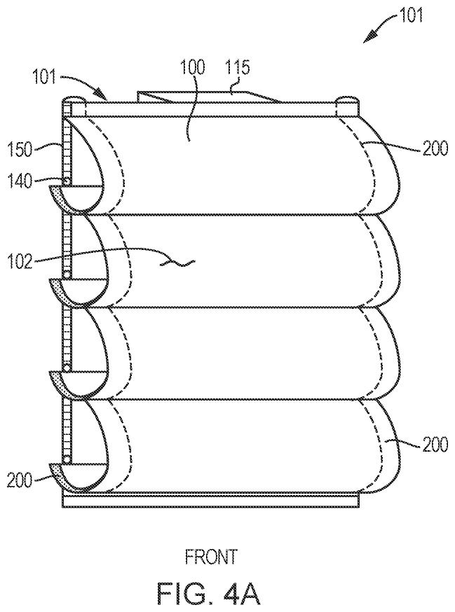

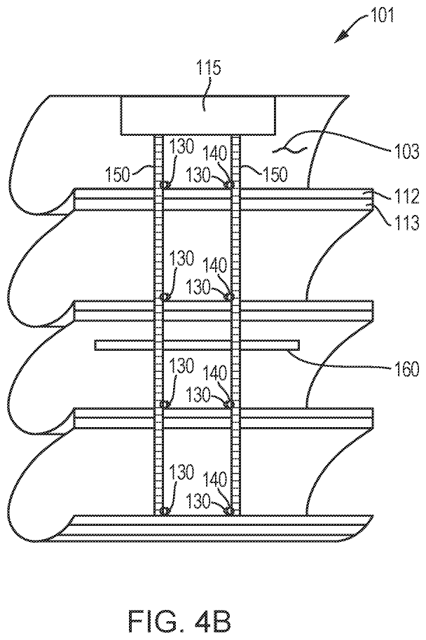

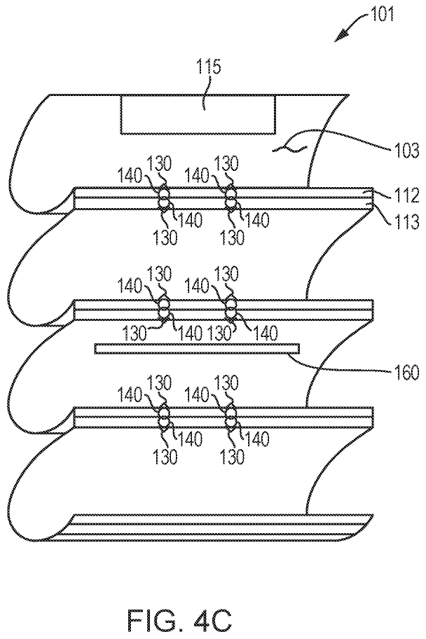

FIGS. 4A and 4B are, respectively, a front side and a back side of a hobbled Roman shade based on the engagement of openings 140 with ribbons 150. Thus, the flat front roman shade of FIG. 3 may be transformed to a hobbled Roman shade of FIG. 4 according to the one or more embodiments as described herein. For visual clarity, some elements (e.g., pull string 125 and pull cord 120) are not included in FIGS. 4A and 4B. However, it is expressly contemplated that shade 101 of FIGS. 4A and 4B includes all the components included in FIGS. 1A, 1B, and 2. Although FIG. 4B depicts openings 140 engaging with ribbon 150, it is expressly contemplated that adjacent openings 140 (e.g., openings 140 of raising clips 130) may be coupled to each other in a variety of different ways to transform the shade 101 to a hobbled or teardrop Roman shaded according to the one or more embodiments as described herein. For example, FIG. 4C depicts shade 101 that is transformed to a hobbled or teardrop Roman shade based on the coupling of is adjacent openings 140.

Although the above description describes engaging the opening 140 with the ribbons 150, it is expressly contemplated that the raising clips 130 may include a securing mechanism instead of openings 140, and the securing mechanism of raising clips 130 may engage with ribbons 150 that includes a securing mechanism.

In a further embodiment, and as depicted in FIG. 4B, one or more strengthening rods 160 may be attached to the back of the shade 101 to provide rigidity and structure to the hobbled shade. The strengthening rods 160 may be secured to the back of the shade 101 at any of a variety of different locations and utilizing any of a variety of different securing mechanisms.

Thus, the shade 101 according to the one or more embodiments described herein may be modified in width and/or height as described herein. In addition or alternatively, shade may be transformed in terms of type (e.g., flat front to a hobbled Roman shade).

In addition or alternatively, the one or more back transforming members 112 and 113 on the back side of the shade 101 may also be utilized to create horizontal folds, as depicted in FIG. 4B, that run horizontally across the cloth 100 to modify the height of the shade 101. In a similar manner as described above with reference to FIG. 2, a user may create one or more horizontal folds at one or more particular locations by pinching the front side 102 on the cloth 100 such that securing mechanisms, of adjacent back transforming members on the back side 103 of the cloth 100, may engage with each other to modify the height of the shade.

In an embodiment, the shade as described herein may not include one or more of raising clips 130, openings 140, pull strings 125, and/or strengthening rods 160. When the shade 101 does not include raising clips 130, openings 140, and pull string 125 to raise/lower the shade, the shade may utilize a motor (not shown) or spring roller system to raise and lower the shade as known by skilled in the art.

In this embodiment, the shade may still be adjusted in terms of length and width as will be described in further detail below. Additionally, the shade may transform or transition between different types of shades as will be described in further detail below.

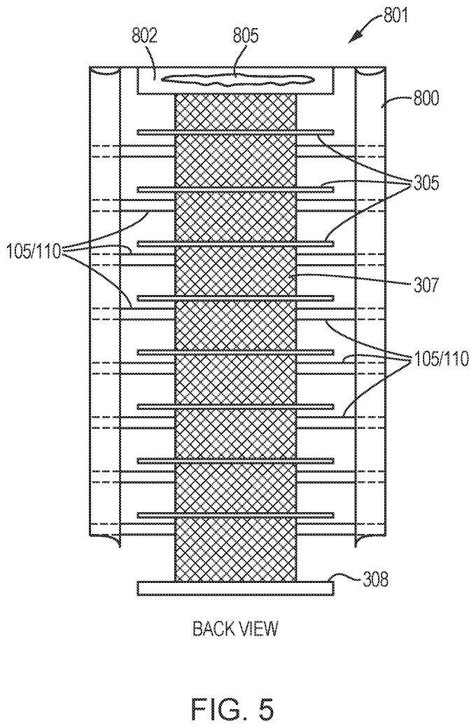

FIG. 5 is example shade 801 without raising clips 130, openings 140, and pull string 125. Instead of including these features, shade 801 may include a headrail 802 that surrounds a spring roller system 805 to raise and lower the shade 801. The cloth 800 of shade 801 may be coupled to the head rail unit 802 utilizing any of a variety of different types of securing mechanisms as described herein. Further, the spring roller system 805 may be coupled to the head rail 802 utilizing any of a variety of different types of securing mechanisms as described herein. It is expressly contemplated the head rail unit 802 and spring roller system 805 may each have any width that does not, for example, have to match the width of the cloth 801. Therefore, the shade 801 of FIG. 5 may be raised or lowered based on a user, for example, pulling on cloth 800 of shade 801 and/or liner 307. Although the example of FIG. 5 is described to include a spring roller system, it is expressly contemplated that the one or more embodiments as described herein are applicable to any of a variety of raising/lower mechanisms for shades.

Additionally, and as depicted in FIG. 5, shade 801 includes one or more attachments rods 305. Although FIG. 5 includes attachment rods 305, it is expressly contemplated that shade 801 can include attachment rods 305, strengthening rods 160 is (not shown), and/or a combination of attachment rods 305 and strengthening rods at any location on shade 801. In this embodiment, the attachment rods 305 and/or strengthening rods 160 may provide rigidity or structure to shade 801. The attachment rods 305 may be made of a light weight or soft material if it is desirable for the shade 801 to have less rigidity and/or structure. In an implementation, the shade 801 may include both attachment rods 305 and strengthening rods 160.

In FIG. 5, there are a specific number of attachment rods 305 attached to the back side 103 of the cloth 800 of shade 801. However, it is expressly contemplated that shade 801 may include fewer (e.g., 1) or more attachment rods 305 at different locations along the shade 801. Further, although FIG. 5 depicts a single attachment rod 305 traversing horizontally across cloth 800, it is expressly contemplated that the attachment rod 305 may include a plurality of attachment rods 305 that are coupled to each other and that may or may not overlap to, for example, increase the overall size of rod 305. For example, overlapping attachment rods 305 may be utilized according to the one or more embodiments as described herein. Overlapping attachment rods 305 may be utilized to accommodate shades of different widths. Further, the attachment rods may be removed and attached to the cloth 800 by a user. Alternatively, the attachment rods 305 may be permanently attached cloth 800. Additionally, attachment rods 305 may be attached to the cloth 800 through use of any of the variety of securing mechanisms as described herein. In an embodiment, the openings 140 may be permanently, e.g., sewn, to the cloth 800.

Although FIG. 5 depicts the attachment rods 305 appearing horizontally across cloth 800, it is expressly contemplated that the attachment rods may be attached to the is back side 103 of cloth 800 in any of a variety of different directions and configurations to create different designs and aesthetics.

Furthermore, it should be understood that the attachment rods 305 can be easily attached and/or detached to the shade 801 by a user utilizing any of a variety of different attachment mechanisms (hooks and loops, self-engaging hooks and loops, magnets, buttons, zippers, snaps, belt loops etc.) that may be on the exterior of the attachment rods 305 and/or cloth 100. This may allow a user to remove particular attachment rods 305 and places them at different locations and with different configuration to modify the design of shade 801. Additionally, and because the attachment rods 305 can be easily removed, the cloth 801 can then be easily removed from the head rail 802 such that the cloth 801 can be cleaned, changed to a different fabric, etc. Additionally, and because the cloth can be easily removed, the spring roller system 805 may be removed from the head rail 802 and replaced with a different raising/lowering system, e.g., motor system. As such, the one or more embodiments as described herein provide a user with flexibility and ease of use which are not provided by conventional shades. The shades according to the one or more embodiments as described herein may be child safe since no cords or pull strings are exposed through use of the spring roller system.

As depicted in FIG. 5, the shade 801 also includes liner 307 and bottom bar 308. In an embodiment, liner 307 may be a blackout liner. In this embodiment, the bottom bar 308 may be coupled to a portion on liner 307 that is lower than the lowest attachment rod 305 that is coupled to cloth 800. When the shade 801 is covering the entirety of a window opening (not shown) and the spring roller system is activated (e.g., user pulls on cloth 800 and/or 308), the liner 307 may roll up while the cloth 800 may fold up to create is pleats/folds.

According to the one or more embodiments as described herein, the location of the attachment rods 305 on the shade 801 may control/dictate the creation of the pleats/folds and the size of the folds on the front side 102 of the shade 801 as will described in further detail below. In an embodiment, pleats/folds may be referred to as hobbles.

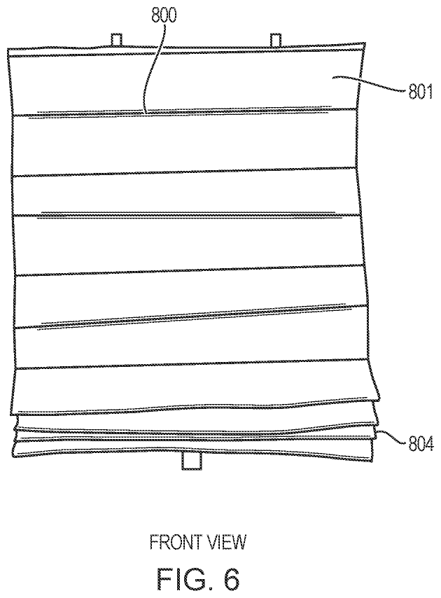

Specifically, and when a user pulls the bottom of cloth 800 and/or bottom bar 308, the liner 307 rolls up and the cloth 800 retract and folds to raise the shade 801 such that a pleats/folds are created at a plurality of locations where each location corresponds to a location of each attachment road 305 on the back of shade 801. Specifically, pleat/fold 804 can be created between respective attachment rods 305 that are on the back side 103 of cloth 800. That is, the position of the attachment rods 305 on the back side 103 of cloth 800 causes pleats/folds on the front side 102 of the cloth 800 to be formed between the attachment rods 305 as depicted in FIG. 6.

Additionally, the liner 307 is positioned between the attachment rods 305 and back side 103 of cloth 800. The liner 307 retract and “roll up” based on activation of the spring roller system (e.g., the user pulling on cloth 800 and/or bottom bar 308). In this example, let it be assumed that the vertical positions along the height of the liner 307 are along a z-axis. Additionally, let it be assumed that the horizontal positions along the width of the liner 307 (e.g., left to right) are along an x-axis. Further, let be assumed that the positions along the thickness of the liner 307 are along the y-axis. That is, the y-axis as described herein runs perpendicular through the window for which the shade 801 may be utilized.

The liner 307 may act as an alignment structure or axis such that y-position of all the attachment rods 305 remain relatively constant, or within a slight variation of each other, as the shade 801 raises through activation as described above. Specifically, because the liner 307 is positioned between the cloth 800 and attachment rods 305, the y-positions of the attachment rods 305 stay relatively constant as the shade 801 is raised. That is, the attachment rods 305 remain substantially vertically aligned, along the described y-axis, as the shade 801 is raised through use of the liner 307.

In an embodiment, substantially aligning vertically means that the y-position of an attachment rod 305 on the back side 103 in relation to each other attachment rod 305 is substantially the same when the shade 801 is not raised and when the shade 801 is raised. For example, let it be assumed that there are 4 attachment rods from the top to the bottom of a shade when the shade is completed lowered and covering the entirety of a window opening. Specifically, the top most attachment rod is the 1^{st} attachment rod, the next attachment rod is the 2^{nd} attachment rod, the next attachment rod is the 3^{rd} attachment rod, and the last attachment rod is the 4^{th} attachment rod.

Therefore, and when the shade 801 is raised, the order of the attachment rods 305 from top to bottom stay in the same order and the y-position of the attachment rods 305 stay relatively the same through utilization of the liner 307 and bottom bar 308. Further, and because of the equal spacing of attachment rods 305 on the back side 103 of cloth 800, the pleats/folds 804 are uniform on the front side 102 of cloth 801.

The bottom bar 308, which is attached to at a lowest position on liner 307, may first make contact with the 4^{th} attachment rod as the shade rises and the liner 307 rolls up. When the shade is further raised and the liner 307 further rolls up, the top of the 4^{th} attachment rod may contact the bottom of the 3^{rd} attachment rod, and so forth such that the attachment rods 305 are aligned (e.g., the y-positions are relatively the same) throughout the raising of the shade 801. The contact is achieved through use of the liner 307 that causes the bottom bar 308 and attachment rods to stay substantially aligned with each other.

Advantageously, the attachment rods 305 on the back side 103 of shade 801 cause the shade 801 to be raised in a unified and “clean” manner such that the appearance of the raised shade 801 is aesthetically pleasing. By aesthetically pleasing, it is a meant that (1) a pleat/fold 804 is relatively uniform and is not crooked, e.g., a left side of a pleat/fold 804 is higher than a right side of pleat/fold 804, and/or (2) a pleat/fold 804 lays relative flat because the two attachments rods 305 that surround a pleat/fold 804 remain relatively vertical and do not become unaligned or intertwined.

Without the liner 307 and/or bottom bar 308 according to the one or more embodiments as described herein, the attachment rods 305 may intertwine and/or become unaligned such that the shade rises in a tangled or unclean manner which is visually unappealing. Additionally, and if the attachment rods 305 are intertwined and/or unaligned, the shade may not lower correctly or may not lower at all. As such, the user of the liner 307 and/or bottom bar 308 provide an advantage over existing conventional shades.

Although FIG. 5 depicts attachment rods 305 being rigid structures, it is expressly contemplated that the attachment rods 305 may be replaced with attachment cloths (not shown) and according to the one or more embodiments as described herein. A shade with attachment cloths 305 would operate in a similar manner to a shade with attachment rods 305, however the shade with attachment cloths would have less rigidity and structure. The attachment cloths may be attached to the back side 103 of cloth 800 utilizing any of a variety of different securing mechanisms as described herein. Further, the attachment cloths may be sewn to the back side 103 of cloth 800.

The shade 801 may be modified in terms of width in a similar manner as described above with reference to shade 101. For example, the back transforming members 112 and 113 (not included in FIGS. 5 and 6 for simplicity) may be utilized to transform the width of shade 801 as described above. Alternatively, the cloth 800 may include a self-engaging securing mechanism such that the cloth 800 may be folded over on the left and right sizes such that the edge of the back side 103 of cloth 800 may be attached to a more interior portion of the back side 103 of cloth 800. Further, although FIG. 5 depicts attachments rods 305 having the same width, it is expressly contemplated that the attachment rods 305 may each have different widths according to the or more embodiments as described herein.

In an implementation, the height of the shade 801 may be modified as described above with reference to shade 101 and utilizing front transforming members 105 and 110 (not shown for simplicity). Alternatively, the shade 801 utilizing any of a variety of different techniques as described above with reference to shade 101 to modify the height of shade 801. Even further, the height of the shade may be modified by activating the spring roller system (not shown) such that a plurality of folds are created at the bottom of the shade 801. The further that the shade 801 is raised, the more folds are created and the height of the shade 801 is decreased.

Even more, the shade of 801, that is a flat front shade with pleats/folds 804 as is described above, may be transformed to a hobbled shade. Specifically, and as described above, attachment rods 305 may be attached to back side 103 of cloth 800 when, for example, the shade 801 is closed and covering the entirety of a window opening. A particular attachment rod 305, which is still secured to the back side 103 of cloth 800, may be raised and attached to different attachment rod 305 that is above the particular attachment rod 305. Specifically, a securing portion of the particular attachment rod 305 may mate with the a different portion of the above attachment rod 305. Alternatively, the particular attachment rod 305 may be coupled to the above attachment rod 305 or the securing portions of the above attachment rod 305 in any of a variety of different ways.

Because the particular attachment rod 305 is raised and attached to the securing portion of an above attachment rod 305 when the particular attachment rod 305 is still secured to the back side 103 of cloth 800, a hobble is created on the front side 102 of shade 801 in a similar manner as described above in relation to FIGS. 4A and 4B.

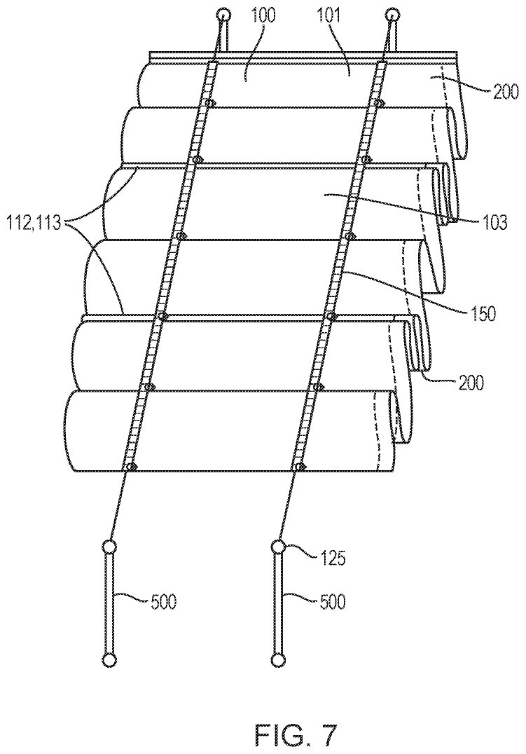

In an implementation, the shade 101 and shade 801 according to the one or more embodiments described herein may be utilized in different environments and/or for different purposes. For example, the shade 101 according to the one or more embodiments described herein may be utilized as an awning as depicted in FIG. 7. Specifically, the awning may include 4 legs 500 with first ends that make contact with a ground surface. In an implantation, the legs 500 may be made of any type of material (e.g., metal, wood, etc.) The other ends of the legs 500 may contact ends of ribbons 150 which travel horizontally and contact and are secured to the back 103 of the shade 101 as described above. In an embodiment, the ribbons 150 of FIG. 7 may be made of any type is of material (e.g., metal, wood, etc.) The awning of FIG. 7 may be modified in width, height, length and transformed to a different type of awning (e.g., without pleats/folds or with pleats/folds), in a similar manner as described above. Additionally, the awning of FIG. 7 may be opened in closed utilizing the pull cord, in a similar manner as described above.

It is expressly contemplated that the different features described with respect to particular figures may apply to each of the different embodiments described herein. For example, although the one or more strengthening rods 160 are depicted in FIG. 4B, it is expressly contemplated that any of the other shades as illustrated in other figures may also include one or more strengthening rods 160. For example, although one or more FIGS. as described herein may include a head rail 115, it is expressly contemplated that each of the shades according to the one or more embodiments as described herein may not include a head rail 115 and still be modified in terms of height, width, and type (e.g., flat front to hobbled).

What is claimed is:

1. A shade, comprising:
A cloth configured to cover a window opening, wherein the cloth includes a front cloth side and a back cloth side;
a plurality of transforming members each (1) having a first dimension that is less than or equal to a width of the cloth, and (2) having a first transforming side and a second transforming side, wherein the first front side of each the plurality of transforming member is coupled to the front cloth side or the back cloth side of the cloth;
wherein when excess cloth material of the cloth that extends past the first dimension of the plurality of transforming members is coupled at a plurality of different locations on the back of the shade to modify an overall width of the shade;
the second transforming side of at least two adjacent transforming members, of the plurality of transforming members, configured to be coupled together to modify an overall height of the shade; and
a plurality of clipping components configured to couple to the back cloth side, wherein each of the plurality of clipping components is coupled to the back cloth side at a first different vertical position of the cloth;
at least two adjacent clipping components, of the plurality of clipping components, configured to be coupled together to transform the shade from a first type of shade to a second type of shade.

2. The shade of claim 1, wherein the first type of shade is a flat front Roman shade and the second type of shade is a hobbled shade.

3. The shade of claim 1, further comprising:
a securing mechanism on the back side of the second transforming side of the at least two adjacent transforming members, wherein the securing mechanism of the at least two adjacent transforming members mate to couple together the at least two adjacent transforming members.

4. The shade of claim 3, wherein the securing mechanism is one of hooks and loops, self-engaging hook and loops, magnets, buttons, zippers, snaps, belt loops.

5. The shade of claim 1, further comprising a head rail unit configured to be coupled to a top end of the cloth.

6. The shade of claim 5, wherein the head rail unit houses a raising mechanism that includes one or more pull strings, retractable sheath, or other raising mechanism.

7. The shade of claim 6, wherein the shade includes the sheath, the shade travel an overall length of the shade and each of the one or more pull strings is configured to engage with at least one corresponding clipping component of the plurality of clipping components when the pull string retracts during a raising of the shade.

8. The shade of claim 1, further comprising:
a plurality of attachment rods attached at second different vertical positions on the back side of the cloth;
a sheath positioned between the cloth and each of the plurality of attachment rods, wherein when the shade is raised, the sheath retracts and engages with the plurality of attachment rods.

9. A shade, comprising:
A cloth configured to cover a window opening, wherein the cloth includes a front cloth side and a back cloth side;
a plurality of transforming members each (1) having a first dimension that is less than or equal to a width of the cloth, and (2) having a first transforming side and a second transforming side, wherein the first front side of each the plurality of transforming member is coupled to the front cloth side or the back cloth side of the cloth;
wherein when excess cloth material of the cloth that extends past the first dimension of the plurality of transforming members is coupled at a plurality of different locations on the back of the shade to modify an overall width of the shade;
the second transforming side of at least two adjacent transforming members, of the plurality of transforming members, configured to be coupled together to modify an overall height of the shade; and
one or more ribbons traveling a length of the shade;
a plurality of clipping components each configured to couple to the back cloth side and the one or more ribbons, wherein each of the plurality of clipping components is coupled to the back cloth side at one or more ribbons at a same vertical position; and
wherein each of the plurality of clipping components is configured to stay at the same vertical position on the cloth and move to a plurality of different positions on the one or more ribbons to transform the shade from a first shade type to a second shade type.

10. The shade of claim 9, wherein the first type of shade is a flat front Roman shade and the second type of shade is a hobbled shade.

11. The shade of claim 1, further comprising:
a securing mechanism on the back side of the second transforming side of the at least two adjacent transforming members, wherein the securing mechanism of the at least two adjacent transforming members mate to couple together the at least two adjacent transforming members.

12. The shade of claim 11, wherein the securing mechanism is one of hooks and loops, self-engaging hook and loops, magnets, buttons, zippers, snaps, belt loops.

13. The shade of claim 9, further comprising a head rail unit configured to be coupled to a top end of the cloth.

14. The shade of claim 13, wherein the head rail unit houses a raising mechanism that includes one or more pull strings, retractable sheath, or other raising mechanism.

15. The shade of claim 14, wherein the shade includes the sheath, the sheath travel the overall length of the shade and each of the one or more pull strings is configured to engage with at least one corresponding clipping component of the plurality of clipping components when the pull string retracts during a raising of the shade.

16. The shade of claim 9, further comprising:
a plurality of attachment rods attached at second different vertical positions on the back side of the cloth;
a sheath positioned between the cloth and each of the plurality of attachment rods, wherein when the shade is raised, the sheath retracts and engages with the plurality of attachment rods.
